(19) United States
(12) Patent Application Publication
(10) Pub. No.: US 2005/0183133 A1
(43) Pub. Date: Aug. 18, 2005

(54) Web-based television

(76) Inventor: Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,696

(22) PCT Filed: May 22, 2003
(86) PCT No.: PCT/IB03/02222

(30) Foreign Application Priority Data
May 27, 2002 (EP) 02077063.2

(51) Int. Cl. H04N 7/173; G06F 13/00; H04N 5/445; G06F 3/00

(52) U.S. Cl. 725/120; 725/38; 348/731

(57) ABSTRACT

In a transmission system, a web site (90) stores information parts for providing additional information and/or functionality for corresponding content parts of a transmitted title. The content parts are identified in a predetermined addressing format for storage (“content part address”) on a removable storage medium. The receiver (60) receives linking information linking the transmitted title to the web site, and a data file including data associating, for respective content parts of the title, the corresponding content part address with a content part timing that identifies the content part in a transmitting timing format. A controller (250) of the receiver uses the linking information and the data file to, synchronous to the receiver supplying content parts of the transmitted title for rendering, enabling linking to the corresponding information parts on the web site.

### FIELD OF THE INVENTION

The invention relates to web TV, where the receiver can obtain additional information for a transmitted title by linking to a web site.

### BACKGROUND OF THE INVENTION

New forms of consumer electronics products are continually being developed. Many efforts have been focused on the convergence of computer technology and home entertainment systems that center on the television (TV) set. Important areas are interactive television and enhanced functionality, by merging broadcast television and Internet. WO 01/11874 describes a system wherein WWW uniform resource locators (URLs) are simulcast with TV signals. For example, URLs may be included into the vertical banking interval (VBI) of a broadcast TV signal or in a separate data channel of a digital TV video stream. When prompted by a message in the TV broadcast, the user may select one or more of the URLs to contact a web site over Internet and perform a transaction or obtain additional information relating to the broadcast. Such information may, for example, be information on the actors, directors, etc.

WO 01/1 1874 further describes that the broadcast receiver also includes a storage device. If the user wants to access the web site, display of the broadcast is temporarily halted and the web content is displayed on the screen. The broadcast title is in the mean time recorded in the storage device and display of the title is continued from storage when the user has finished accessing the web.

A drawback of the known web TV system is that a considerable effort is required for each broadcast title to enhance the title with attractive web-based content

### SUMMARY OF THE INVENTION

It is an object of the invention to provide an enhanced web TV system.

To meet the object of the invention, the transmission system includes at least one receiver, a transmitting system for transmitting a title to the receiver, and a web site for storing information parts for providing additional information and/or functionality for corresponding content parts of the title; the respective content parts of the transmitted title being identified in a predetermined addressing format for storage on a removable storage medium; the receiver being operative to receive: the transmitted title, linking information linking the transmitted title to the web site, and a data file including data associating, for respective content parts of the title, information identifying the content part in the addressing format for storage (hereinafter “content part address”) with information identifying the content part in a transmitting timing format (hereinafter “content part timing”); and the receiver including a controller for, under control of a conversion application, synchronous to the receiver supplying content parts of the transmitted title for rendering where the content parts are identified using the content part timing, enabling linking to the corresponding information parts on the web site indicated by the linking information, using the data file to, based on the content part timing of the transmission, determine the content part address, and/or based on the content part address determine the content part timing.

WO 00/63915 describes a system that integrates a DVD system with a WWW web browser. Universal Resource Locator (URL) information corresponding to sites accessible by the browser is stored in fields within the DVD data When the user actuates a DVD element that has a corresponding URL, the web browser displays information from that site. When the user actuates an HTML menu or other browser-implemented feature, the DVD system accesses a portion of the DVD data specified in the menu. This arrangement provides for two-way communication, i.e. HTML in the browser is able to control DVD content and vice versa. Having a link between the web information and the DVD content makes it possible to present web content synchronous with the rendering of DVD information.

According to the invention, it is enabled to transmit a title, such as the described DVD title, to a receiver and present the web information synchronous to rendering the received title. To this end, linking information is provided to the receiver to enable a browser in the receiver to locate the web site. It should be noted that web content on the original web site is linked to content parts of the title on the storage medium (e.g. the DVD), where the content parts are identified using an addressing scheme defined for the removable storage medium (e.g. the DVD addressing scheme). The content parts of the transmitted title are identified using a suitable broadcast time stamp scheme. To enable the receiver to use the web content, according to the invention a conversion table is provided to the receiver that enable the controller of the receiver to convert one form of identification to the other form. The direction of mapping may be optimally chosen for the specific system. For example, in some systems or for certain titles, presentation of the additional web-based information may be primarily driven by the presentation of the title (i.e. the title is rendered and the web content is retrieved when required for the rendering of the title). In this case, for many content parts (identified in the addressing format) links to web content may be provided. During the rendering of the title, for content parts identified in the timing format the provided table may be used to determine the addressing format and use that format to determine the link. In a preferred embodiment, most weight is given to the web site for controlling the rendering. In such an approach it is easier to subsequently develop the site further and to improve the web site. In such a scenario, emphasis is given on processing the web site, where for much of the additional information parts on the web site it is indicated to which part of the content (in the addressing format) it relates. The controller can then use the provided data file to convert the content part address to the content part timing to enable synchronous rendering.

In the system according to the invention, web sites developed for stored content can be re-used by once developing a conversion application to be executed by the receiver, where for each title only a conversion table needs to be created. In this way, web enhanced transmissions can be created very fast for all content, like movies, for which the significant effort of enhancing the content has already been done for the purpose of distributing the title on the removable storage medium.

Preferably, the title is being broadcast by the transmitter to the receiver (and all other receivers in the system). The title may also be multicast, i.e. sent in one simultaneous operation to a plurality of receivers (but usually not all) that have been selected for receipt. For example, only those receivers that have paid for receipt. In principle, the title may also be directly transmitted to the receiver, e.g. by addressing it to the receiver or using a dedicated link.

As described in the dependent claim 2, some parts of the original title as made for distribution on the storage medium may be removed from the transmitted title (e.g. to reduce the length). To avoid that web-based content is rendered for parts not present in the transmitted title, the data file includes information that enables the controller in the receiver not to render such web content.

As described in the dependent claim 3, also content parts may be added to the transmitted title that were not present in the original stored version of the title. For the additional content parts, also web-based content may be made available through a different (or the same) web site.

As described in the dependent claim 4, the conversion application program is pre-stored in the receiver. Since, according to the invention the application needs to be developed only once, it can be pre-stored. This enables optimal, platform specific coding of the application, reducing costs.

As described in the dependent claim 5, the transmitter provides the conversion application, for example in the form of an Xlet (Java application optimized for a broadcast receiver platform). In this way, it is possible to control distribution of the application, for example to paying customers, and to easily update the application. A major advantage is that for most platforms, like MHP, a framework for distribution and working of such applications has been defined. By using such framework, no further standardization activities are required, which normally are required for interaction between a transmitter and receiver.

As described in the dependent claim 6, the receiver downloads the application from a web site, for example, from the web site including the enhanced content or the web site of the manufacturer of the receiver. Particularly, downloading via the web site with the enhanced content enables increasing the functionality of the application in line with the functionality provided by the web site.

As described in the dependent claim 7, the data file (and optionally also the linking information) may be combined with the conversion application, for example forming one integrated Xlet. In this way the application and the conversion data can be optimally matched, although usually coming at an increased cost compared to only newly providing the conversion data.

As described in the dependent claim 8, the transmitting system broadcasts the data file and/or the linking information. This is an effective way of distributing the data to several receivers while keeping the load on the transmitting medium to a minimum.

As described in the dependent claim 9, in the receiver or attached to the receiver a storage system is used for recording the transmitted title. Also the linking information and data file are recorded. This enables subsequent rendering from the local storage. Moreover, additional functionality that is not possible during a real-time transmission can be made available. For example, VCR or DVD-like menu's can be made available that enable a user to continue the rendering from a previous location (such as a DVD chapter), to pause playback, and perform winding/rewinding functions. To this end, the receiver determines whether the title is provided in real-time or from storage. For rendering from storage more functionality is made available.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a digital broadcast system wherein the invention can be used;

FIG. 2 shows a block diagram of a receiver for use in the system; and

FIG. 3 shows an example of a data file according to the invention.

### DETAILED DESCRIPTION OF THE PREFERRED EMBODIMENT

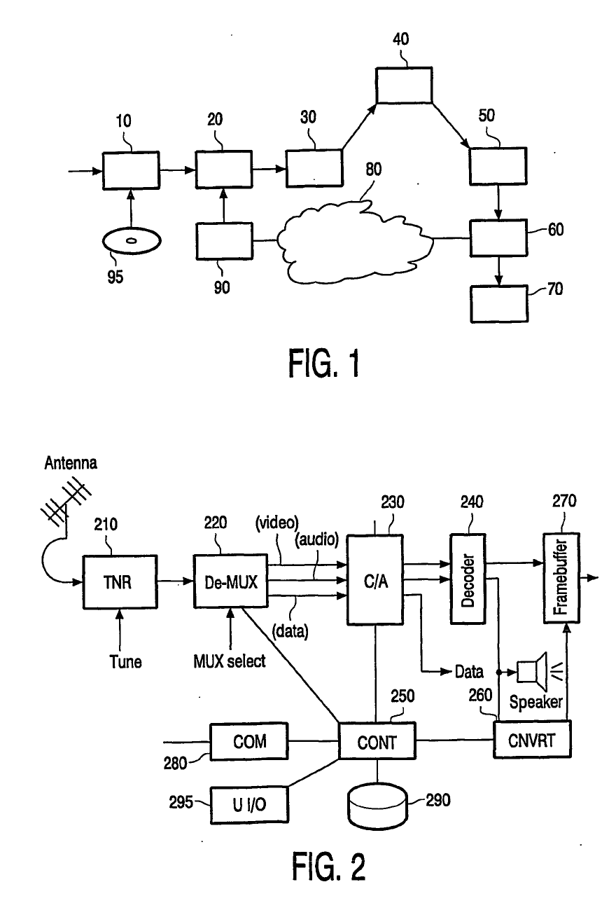

FIG. 1 gives an overview of a digital television system in which the receiver according to the invention can be used. As an example, a system is described wherein the audio/video (A/V) signals are distributed digitally using MPEG-2 compression to compress the A/V signals. The system includes an MPEG-2 compressor 10, usually located in a broadcast centre. The compressor receives a digital signal stream (typically a stream of digitized analog or digital video signals). The original signals are supplied by a service provider. The compressor is connected to a scrambler and multiplexer 20. The scrambler scrambles the digital signals of a data stream by encrypting them under control of a content key, as will be described in more detail below. The multiplexer 20 may receive in addition to one or more scrambled or non-scrambled data stream also further digital signals. The multiplexer 20 assembles all the signal and streams into a transport stream and supplies the compressed and multiplexed signals to a transmitter 30 of the broadcast centre. The scrambling and multiplexing functions may be performed in separate units, and if desired at different locations. The multiplexed transport stream may be supplied from the scrambler/multiplexer 20 to the transmitter 30 using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. In the figure, the satellite receiver 50 is connected to an integrated receiver 60. The operation of the receiver 60 is described in more detail below with reference to FIG. 2. The receiver selects the desired signal and presents it in a suitable form to a rendering device, such as a television 70. The signal may also be recorded using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams. It will be understood that the main distribution of the AV signals does not need to take place via satellite. Instead other delivery systems (i.e. the physical medium by which one or more multiplexes are transmitted) may be used, such as terrestrial broadcast, cable transmission, combined satellite/cable. The party that distributes the program via the delivery system is sometimes referred as the network provider. It will also be understood that the receiver/decoder 60 may be integrated into the rendering or recording device.

A typical system operates as a multi-channel system, implying that the multiplexer 20 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these services/channels interlaced with the transmitted digital audio and video information. As such a transport stream includes one or more services, each with one or more service components. A service component is a mono-media element. Examples of service components are a video elementary stream, an audio elementary stream, a Java application (Xlet), or other data type. A transport stream is formed by time-multiplexing one or more elementary streams and/or data.

Preferably, bi-directional communication is enabled in the system to facilitate interactive applications, such as interactive video, e-commerce and so on, and to enable the receiver to obtain additional information/functionality from the web site. Shown is the use of a wide area network 80, preferably the open Internet, where the added functionality and interactivity is provided by a web site on a web server 90. To enable broadcasting or multicasting of data or applications stored on the web site, preferably, the web server 90 also has a connection to the multiplexer 20. This may be a direct link but may also be via the Internet. It will be understood that the communication functionality of Internet or similar communication system may be provided in any suitable form. For example, the receiver may communicate via a cable network or satellite connection, directly using Internet protocols. Alternatively, the receiver may have a telephone-based dial-in connection to an access provider that provides access to the Internet. The receiver may, but need not use Internet protocols. If the server 90 does use Internet protocols, protocol conversion may take place, for example using a gateway.

Although the system according to the invention is described for a digital broadcast system, in principle the invention can also be applied for non-broadcast transmissions. For example, the same concepts can be applied easily where a title is supplied to individual receivers, for instance on a pay-per-view basis. The transmission may then take place via a typical broadcast system (but directly addressed) or via other suitable systems, such as a high-bandwidth Internet connection.

FIG. 1 also shows a removable storage medium, such as CD-ROM, DVD, or solid state memory, which stores AV data. Typically, the AV title is a movie or similar AV data for which enhanced functionality has already been developed once. Usually, the title was stored in a compressed form, for example using MPEG-2 coding. For transmission, the title may be changed, for example some parts may be removed, for example to reduce the length, and some other part, like commercials, may be added. Consequently, the title will usually be re-coded. Using the exemplary digital transmission system of FIG. 1, this is shown by feeding the title through the coder 10. The title will anyhow be multiplexed into the transport stream by the multiplexer 20. Of course, the title need not be taken from the storage medium 95 but may also in an original version be supplied by a studio.

For the title, enhanced functionality has been made available via the Internet through a web site. The web site may, but need not be the same, as the one used when transmitting the same title. The original web site contains many additional information parts, of which some have a clear correspondence with content parts of the title. For example, the web site may include more subtitles or languages than the original title on the storage medium 95. For example, a DVD may have been supplied in different versions for different regional areas. As the different versions are developed more languages and sub-titles may be developed as well. Whereas a DVD typically includes 3 or 4 languages and sub-titles in up to 8 languages, the additional information can be added to the web site. For example, this would enable a Dutch viewer in the US to view the DVD with the US region code (and not including Dutch language and Dutch sub-titles) in Dutch. It will be understood that the web site then contains information on synchronizing (“linking”) the information on the web site to corresponding content parts of the title. In theory, such linking information can also be embedded in the DVD, but it is preferred to let the web site couple the web information to the content in order to be more flexible. As a further example, after the DVD has been completed (and distributed) more functionality may be added, for example an interview with the director, script writers, or actors may be stored on the web site, where parts of the interview link to content parts being discussed. In this way, the viewer watching the interview (retrieved from the web site) can also view the content parts being discussed. Similarly, games and quizzes may be developed and made available through the web site that may or may not link web-based content to the title content. Further examples of enhanced functionality are:
Enhanced menu structures (compared to the original menus on the DVD)
E-commerce, buying items related to the movie
Promotion of similar/related movie titles
Provide up-to-date profiles of actors, directors, etc.

The web site may be based on a declarative approach. In such an approach the web site does not contain actual program code but instead describes the type of content and the connections (links) between the content parts. Such a web site could be based on HTML, XML or similar descriptive languages. The web site may also be based on a more procedural approach. In this approach an Application Programming Interface (API) has been defined for the receiver for accessing functions of the receiver (including controlling the content received by the receiver), for example similar to a Java Virtual Machine.

FIG. 2 shows more details of a typical broadcast receiver. The broadcast receiver, preferably, complies with a defined platform like the European MHP (Multi-media Home Platform) or the US DASE platform. The broadcast receiver includes a tuner 210. The tuner 210 extracts a separate tunable Radio Frequency (RF) band usually resulting in an MPEG2 transport stream. Variable data signals are separated from the constant carrier signal by the de-multiplexer 220 (De-MUX). The results often are audio, video and data outputs. The video and audio streams may be fed through a Conditional Access subsystem 230, which determines access grants and may decrypt data. The audio and video streams are fed to a decoder 240, which converts them into signals appropriate for the video and audio rendering or storage devices. This may involve MPEG2 decoding. The receiver also includes the communication interface 280 for bi-directional communication to the web site. Any suitable communications hardware/software may be used for this, including conventional modems for standard telecommunication lines or broadband modems. The bidirectional communication channel facilities interactive applications, such as interactive video, e-commerce and so on, and obtaining additional information/functionality from the web site on the web server 90 of FIG. 1. Preferably, Internet protocols are used, for example those defined in the MHP “Internet Access Profile”. The relevant data retrieved from the web site will be converted by a converter 260 (such as an audio D/A converter and a graphics processor) to a suitable form for presentation to a user, for example via a loudspeaker and/or video display. The video may be combined with the video generated by the decoder 240 into one frame buffer 270. In this way, the web-data may be overlaid (e.g. as sub-titles, or as a Picture-in-Picture), or mixed with the video signal. Output of the decoder can be supplied to a rendering device or storage device for subsequent rendering. Shown is an internal storage 290. Typically, the output is first stored in a frame buffer 270 for subsequent supply to the rendering/storage device. For certain applications, the receiver may provide encoded output streams, bypassing the decoder 250. The rendering device may then include the decoder function or the encoded stream may at a later stage be re-supplied to the receiver for further decoding. The encoded data stream may also be recorded in the storage 290 for subsequent rendering. A user interface 295 of the receiver enables the receiver to interact with the user. The user interface 295 may include any suitable user input means, such as an Infrared receiver for receiving signals from an IR remote control, a keyboard, or a microphone for voice control. For output, also any suitable form may be used, such as using a small LCD display or using the display of a television, or even audible feedback.

It will be appreciated that the various functions, such as the tuner function 210, the de-multiplexer function 220, the optional descrambler/decryptor function 230, and the decoder function 240 may be performed using dedicated hardware. Some functions or part of the functions may also performed by a programmable processing function, for instance using a digital signal processor (DSP) loaded with a suitable program. The various functions within the receiver are operated under control of the controller 250, which typically includes an embedded microprocessor or microcontroller. To keep the figure simple, the control relationship between the controller and the other functions are not shown. Only the roles that the controller can have in processing of the web data and synchronizing the presentation of AV content and web content are shown. For presenting the web content, the controller may execute an application similar to web browsers known from PCs. It will be appreciated that for certain information a much simpler application may be used. For example, sub-titles retrieved from the Internet can be overlaid in a way that Teletext sub-titles are overlaid. The user needs not to be aware that the actual added content is retrieved from the web.

According to the invention, the receiver is provided with linking information, and a data file. This information is used by a special application program “a conversion application”.

The linking information enables the controller (under control of the application) to locate the web site with the additional information. In a preferred embodiment, the linking information is relatively simple. For example, the linking information could include the following three links:
1. Synchronous features http:// . . . / . . .
2. Additional information http:// . . . / . . .
3. Storage only features http:// . . . / . . .

The first link is preferably always present. It enables locating additional information that needs to be rendered synchronous with rendering of parts of the title. A separate link (link 2) may be provided for feature that do not require synchronous rendering of the web content and the AV content, for example an actor's biography. This additional link for non-synchronous features may be directed to another web site or to a sub-part of the same web site. The non-synchronous features may but need not have been available for the original stored title. If the title is recorded at the location of the receiver (e.g. using a hard disc or recordable optical storage in or connected to the receiver), more advanced features may become available. For example, menus supporting selection of freely selectable parts of the title, fast forwarding, rewinding type of functions may become available. Also a director's commentary may be intermixed with display of the scenes being discussed. Such features are preferably accessible via the third link. A signal is provided to the controller 250 if the title is reproduced from a local storage (such as the internal storage 290 of FIG. 2) so that the controller can enable use of the additional functionality provided via the third link. In these examples it is assumed that detailed linking as identified parts of the title content or web content is managed by the information on the site. In such a case, the linking information provided to the receiver initially can be high-level, where the detailed linking will occur while processing the web based data.

In order to understand the data file and the conversion application, first a description is given of relevant information of a web-enhanced title distributed on a removable storage medium. Here as an example, DVD will be described. DVD-Video defines navigation data to control playback. This logical structure defines the following units (among others):

| Unit | Maximum |
|---|---|
| Title | 99 per disc |
| Program Chain (PGC) | 999 per title |
| Part of Title (PTT) | 999 per title, 99 per sequential PCG title |
| Program (PG) | 99 per Program Chain (PG) |

The meaning of these units is as follows:
Title—movie, TV program or music album
Program Chain—collection of programs or groups of cells linked together to create a sequential presentation
Program—group of cells within a program chain (PGC)
Part of title (PTT)—a division of a title representing a scene, also called a chapter

For example a DVD-Video disc could contain a single title (the movie) with multiple Program Chains (for different version of the movie). The title is also split into parts (PTTs) which correspond to what the user thinks of as chapters.

Also DVD-Video defines commands for controlling playback (Annex J of the DVD specification) which in some cases will correspond to remote control commands. These commands control playback using the units defined above. Some sample commands are:
Title_Play (Title number)—Play title
PTT_Play (Title number, PTT number)—Play PTT within the title
Time_Play (Title number, Time)—Play title at a specific time
PTT_Search (PTT number)—stop current presentation and start presentation from the beginning of PTT number specified.

The web site developed for the DVD may include features that playback specific parts of the content in non-linear order. The description of these features (whether procedural or declarative) will use the DVD Annex J commands to control playback. For stored content these features can be used within MHP (or similar platform) controlling playback.

The web site may also contain content that is presented along with the main video presentation e.g. subtitles, foreign language soundtrack script and directors notes while video displayed on part of the screen. This content will need to be synchronized with the DVD-Video and stay consistent with the video content even with user operations such as fast forward/rewind, next/previous chapter. These features can be presented to the user during a TV broadcast without requiring the content to be stored.

In both cases it is necessary to have a mapping between the logical navigation structure on the DVD and the timing in the broadcast. In a preferred embodiment, this takes into account the possibility that the movie has been edited for TV so parts have been deleted or that extra content has been added to the broadcast (e.g. commercial breaks, movie split with news bulletin).

MHP defines Normal Play Time (NPT) which is included in the Transport Stream and accessible to the applications. It provides a continuous monotonically increasing time base independent of any timing discontinuities in the broadcast NPT does not need to be included in a broadcast but is part of MHP and so can be used in this case to define the time relation between the DVD content and the broadcast. The NPT can also be paused for some time e.g. during a commercial break the NPT of the main programme will pause. There may be multiple NPTs in the broadcast but only one can be increasing at any point in time e.g. the NPT of the main programme may be paused during an inserted news bulletin during which a separate NPT will increase. Essentially, the NPT is an offset from the Transport Stream timing (based on PCR) but without discontinuities. PCR is an acronym from MPEG-2 Transport Stream. It stands for Program Clock Reference and it is the basic timing in the Transport Stream along with the PTS/DTS times (Presentation Time Stamp and Display Time Stamp). The PCR is repeated in the Transport Stream (e.g. every 100 ms) to give the current time and the PTS/DTS refer to the same timebase as the PCR.

The data file according to the invention provides a mapping from the DVD-Video presentation structure (or more generally: the addressing structure used for identifying the stored content part) to be broadcast, where content parts are identified using broadcast timing information. The details of how this is coded are not important (e.g. using XML) but the data file does define for the content parts of the original stored title that are present in the broadcast the time relation between the two. In a preferred embodiment, the data file also defines which parts of the DVD content are present in the broadcast (or, reversely, are not present in the broadcast) to enable the controller to disable rendering or information parts on the web site that relate to removed content part.

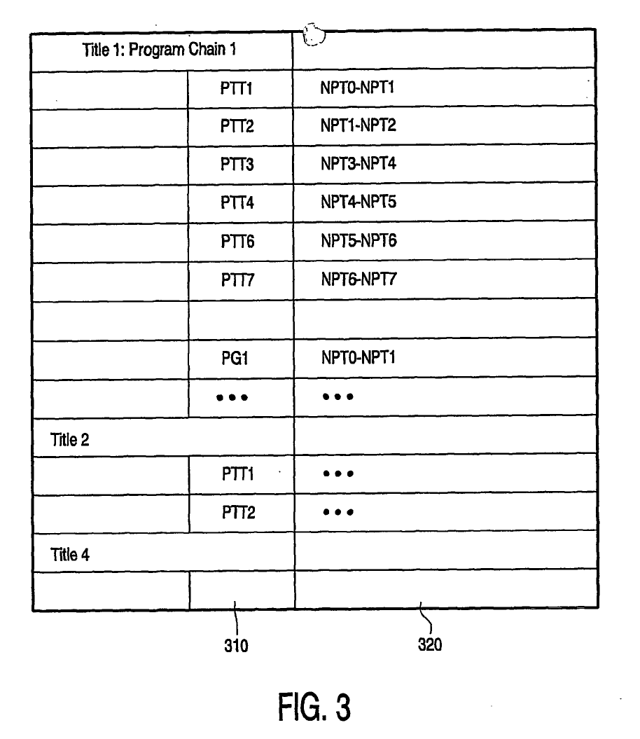

FIG. 3 shows an example of the data file mapping the content part address of DVD (indicated in column 310) to the content part timing (indicated in column 320) in the MHP NPT format In the example, title 1 is divided in seven chapters PTT1 to PTT7. Chapter PTT5 is removed from the broadcast. In the exemplary data file, it is removed from the data file. It will be understood that it may also still be present in the table, where in column 320 it is made clear that it is not present in the broadcast (e.g. by having no value in column 320). As such the data file indicates explicitly or implicitly which content parts of the title have been removed from the broadcast. Based on such information, the controller can disable rendering of any web-based content that relate to content parts not present in the broadcast/transmitted title. Further, it can be noted that there is a gap in the broadcast content compared to the original stored title: PTT 3 starts at timing NPT3 whereas the previous chapter ended at broadcast time NPT2. This gap may be because additional content, like a commercial, has been added in the broadcast that was not present in the original stored content. In the example, also title 3 has been removed in its entirety. Persons skilled in the art will be able to adapt the data file for other storage formats and other broadcast timing formats. As an example, the storage addressing may also be at a more detailed level than chapters, for example at DVD cell level.

The above structure takes the DVD structures and indicates which parts are in the broadcast. Of course an alternative structure would be to start with the broadcast content timeline and indicate for each part which part of the DVD it corresponds to. Depending on what level the web site content references the DVD it may be sufficient to store a subset of this mapping e.g. if the web site doesn't reference Programs (PGs) then there is no need to store the mapping to PGs.

Other systems than MHP may not use the NPT principle, but may have similar mechanisms. If no suitable mechanisms are present, instead a mapping can be given to the timing in the broadcast (based on PCRs) taking into account possible discontinuities. Of course this time information must be available to the Interactive application.

It will also be appreciated that the broadcast may add content for which also support is provided on the web site. Such new content parts need to be identified, for example mimicking the DVD addressing format. Preferably, the new parts are not identified using the transmission timing format. By using a format independent of the transmission, it is made easier to re-use the added content for other transmissions/broadcasts that may use a different transmission identification. The conversion data file includes also conversion data for the added content parts.

In a preferred embodiment, the receiver stores the transmitted title in a storage, such as the internal storage 290 of FIG. 2. In storing a transmitted title, typically also a mapping from the broadcast timing to locations on storage, such as a recordable disc, is stored. This allows support for jumping a certain time within the programme and trickplay (for many applications it may be sufficient to store time/location for MPEG-2 I-frames). This additional mapping enables finding a location in the storage based on the timing in the broadcast. For this invention, the web site would indicate a locations based on, for example, the DVD addressing. The data file indicates a mapping to the broadcast timing and then using the new storage locations it is possible to map again from the broadcast timing to actual locations on disc. If so desired, it is possible to update the data file to provide a direct mapping from the DVD addressing to the addressing on the new storage.

As will be understood, the conversion application needs to be developed only once. It can be pre-stored in a read-only memory (such as ROM) and loaded into the controller when required. It may also be stored in a writeable memory, like flash memory, hard disc, or rewriteable storage. In such a case, it may be received via distribution on a medium like a CD-ROM, it may be transmitted via a communication system like Internet (preferably downloaded from the web site that corresponds to the title or a web site of the set maker), or it may be broadcast by the AV broadcast system, for example as a Java applet (Xlet) in the multiplexed transport stream. It may also be multi-cast to selected receivers, for example those that have subscribed to a particular service. Similarly, the data file and linking information may be retrieved via the Internet (or other communication system), or multi-cast/broadcast by the AV transmission system.

To avoid that the web site for a once recorded title at the moment of rendering of the title is no longer available, in a preferred embodiment the relevant content on the web site is also recorded locally under control of the receiver, for example in storage 290 of FIG. 2. The AV transmitting system preferably broadcasts the web content. If so desired, it may also be directly addressed to an individual receiver or multi-cast to a group of receivers.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitable programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A transmission system including at least one receiver, a transmitting system for transmitting a title to the receiver, and a web site for storing information parts of providing additional information and/or functionality for corresponding content parts of the title; the respective content parts of the transmitted title being identified in a predetermined addressing format for storage (hereinafter “content part address”) on a removable storage medium;
the receiver being operative to receive: the transmitter title, linking information linking the transmitted title to the web site, and a data file including data associating, for respective content parts of the title, the corresponding content part address with a content part timing that identifies the content part in a transmitting timing format;
the receiver including a controller for, under control of a conversion application, synchronous to the receiver supplying content parts of the transmitted title for rendering where the content parts are identified using the content part timing, enabling linking to the corresponding information parts on the web site indicated by the linking information, using the data file to, based on the content part timing of the tranmission, determine the content part address, and/or based on the content part address determine the content part timing.

2. A system as claimed in claim 1, wherein the web site includes information parts relating to removed content parts not present in the transmitted title, but available for distribution on the removable storage medium, the data file indicating the removed content parts; and the controller being operative to disable rendering of information parts on the web site that relate to removed content parts.

3. A system as claimed in claim 1, wherein a further web site includes additional information parts relating to additional content parts present in the transmitted title but not available for distribution on the removable storage medium; and the linking information also linking the transmitted title to the further web site to enable the controller to render the additional information parts synchronous with the receiver supplying the additional content parts for rendering.

4. A system as claimed in claim 1, wherein the conversion application is pre-loaded in a memory of the receiver.

5. A system as claimed in claim 1, where the transmitting system is operative to provide the conversion application to the receiver by transmitting it directly addressed to the receiver or by broadcasting it to a plurality of receivers.

6. A system as claimed in claim 1, wherein the receiver is operative to download the conversion application from a web site.

7. A system as claimed in claim 5, wherein the conversion application includes the data file.

8. A system as claimed in claim 1, where the transmitting system is operative to broadcast the data file and/or the linking information.

9. A system as claimed in claim 1, wherein the receiver is operative to store the transmitted title, linking information, and data file in a local storage system; the data file further including information on information parts (hereinafter “storage-only parts”) on the web site only available when rendering the title from storage; the conversion application being operative to cause the controller to determine whether the title is rendered from a live transmission or from storage and to enable rendering of the storage-only parts on the web site only for rendering of the title from the local storage system.

10. A system as claimed in claim 9, wherein the receiver is operative to store the information on the web site in the local storage system; the conversion application being operative to cause the controller to render, for a title rendered from storage, the corresponding web site information from the local storage system.

11. A system as claimed in claim 10, wherein the transmitter is operative to provide the information on the web site to the receiver by transmitting it directly addressed to the receiver or by broadcasting it to a plurality of receivers.

12. A receiver for use in the system as claimed in claim 1, the receiver being operative to receive:
a title transmitted by a transmitter;
linking information linking the transmitted title to a web site for storing information parts for providing additional information and/or functionality for corresponding content parts of the title; the respective content parts of the transmitted title being identified in a predetermined addressing format for storage (hereinafter “content part address”) on a removable storage medium; and
a data file including data associating, for respective content parts of the title, a corresponding content part address with a content part timing that identifies the content part in a transmitting timing format;
the receiver including a controller for, under control of a conversion application, synchronous to the receiver supplying content parts of the transmitted title for rendering where the content parts are identified using the content part timing, enabling linking to the corresponding information parts on the web site indicated by the linking information, using the data file to, based on the content part timing of the transmission, determine the content part address, and/or based on the content part address determine the content part timing.

13. A computer program product for causing a controller in a receiver to:
process linking information linking a received title to a web site for storing information parts for providing additional information and/or functionality for corresponding content parts of the title; the respective content parts of the received title being identified in a predetermined addressing format for storage (hereinafter “content part address”) on a removable storage medium;
process a data file including data associating, for respective content parts of the title, a corresponding content part address with a content part timing information that identifies the content part in a transmitting timing format; and
synchronous to the receiver supplying content parts of a title received from a transmitter for rendering where the content parts are identified using a content part timing of the transmission, enabling linking to information parts on a web site that correspond to the content parts, where the web site is indicated by linking information, using the data file to, based on the content part timing of the transmission, determine a content part address, and/or based on the content part address determine the content part timing.
